(19) United States
(12) Patent Application Publication
(10) Pub. No.: US 2012/0152761 A1
(43) Pub. Date: Jun. 21, 2012

(54) SELENIUM SEPARATION AND RECOVERY FROM BIOREACTOR SLUDGE

(76) Inventors: Timothy Michael Pickett, Salt Lake City, UT (US); Jill Noreen Sonstegard, Layton, UT (US)

(21) Appl. No.: 12/971,585

(22) Filed: Dec. 17, 2010

(51) Int. Cl. C01B 19/00; C02F 1/70; C02F 1/461; C02F 1/52; C02F 11/00; C02F 1/68; C02F 1/72

(52) U.S. Cl. 205/751; 210/767; 210/696; 210/787; 210/806; 210/773; 210/719

(57) ABSTRACT

Wastewater containing soluble selenium is treated in a bioreactor. Microorganisms in the reactor reduce the selenium to elemental selenium, which is insoluble. The elemental selenium is discharged from the reactor in waste sludge. The sludge is treated to recover selenium. In one method, the sludge is washed with chemicals, for example surfactants, and agitated to disrupt the adhesion of the selenium particles to the cells. The selenium particles are then separated from the cells using a physical separation process such as a centrifuge or differential filtration. In another method, the sludge is de-watered or dried to a very high solids content. The selenium particles are dissolved using an oxidizer under high pH conditions. A solids fraction is removed from the resulting slurry. A resulting selenium brine is further refined to recover the selenium.

### FIELD

This specification relates to wastewater treatment to remove selenium and to the recovery of selenium from wastewater.

### BACKGROUND

The following paragraphs are not an admission that any of the information below is common general knowledge or citable as prior art.

Selenium is a trace element essential for human health. Selenium is also a precious non-metal with several useful properties. For example, selenium has photovoltaic and conductive properties making it useful in photovoltaic and electronic products. Selenium is also used as a pigment in glass and in vitamin supplements and fertilizer.

However, selenium also becomes toxic at very low concentrations. Selenium accumulates in the bodies or plants and fish that live in selenium-contaminated water and in the bodies of wildlife and people that eat those plants and fish. In people, elevated selenium concentrations may cause neurological damage and hair and nail loss.

Selenium may be present in soluble forms (selenate and selenite) in wastewater produced in various industrial or agricultural operations. For example, selenium is often present in flue gas desulphurization blowdown water produced in coal fired power plants. Selenium can also be present in some oil refining and mining wastes. Discharge limits for selenium may be set at between 10 parts per billion (ppb) and 50 ppb.

International Publication Number WO 2007/012181 describes a biological reactor for removing selenium from wastewater. Selenium removing reactors are sold by the General Electric Company, GE Water & Process Technologies under the ABMet trade mark. In these reactors, a fixed media bed supports a biofilm of selenium reducing organisms. The organisms reduce selenate and selenite in the wastewater to elemental selenium, which is insoluble in the wastewater. The selenium is retained in the reactor until it is removed in a waste sludge by a periodic flushing operation.

### SUMMARY

The following summary is intended to introduce the reader to the detailed description to follow and not to limit or define any claimed invention.

The sludge removed from a selenium bioreactor contains elemental selenium and may be classified as a toxic waste. The sludge must therefore be stored or disposed of to prevent selenium leaching into the environment. The cost of storing or disposing of the sludge is significant. On the other hand, the selenium in the sludge is a valuable commodity. Accordingly, recovering the selenium from the sludge produces a useable product and reduces a regulatory and environmental problem.

Analysis of the sludge from ABMet reactors treating FGD blowdown water from a coal fired power plant shows that the sludge contains elemental selenium, other ions and suspended solids, and sloughed biomass. The elemental selenium is typically in the form of nanospheres or other small particles of less than about 0.2 um in diameter. These selenium particles are located outside of the cells of the selenium reducing organisms, but stick to the exo-polymer coating of the cells. The adhesion to the cells appears to be why the selenium particles are not washed from the reactor biomass during normal forward operation.

In a process described herein, bioreactor sludge is washed with chemicals, for example surfactants, and agitated to disrupt the adhesion of the selenium particles to the cells. The selenium particles are then separated from the cells using a physical separation process such as a centrifuge or differential filtration.

In another process described herein, bioreactor sludge is de-watered or dried to a very high solids content. The selenium particles are dissolved using an oxidizer under high pH conditions. A solids fraction is removed from the resulting slurry. A resulting selenium brine is further refined to recover the selenium.

Recovering selenium from bio-treated sludge reduces the cost of waste disposal, or the potential liability for waste storage, for plant owners and operators. Removing the selenium also allows the remaining sludge to be processed further. This may allow a plant operator to reduce the total amount of waste produced beyond the amount represented by the selenium itself.

Recovered selenium, in a form that can be input into a refining operation, is also a valuable product. For example, a typical ABMet system treating 1 million gallons per day (44 L/s) of wastewater containing 1 ppm of selenium collects about 3000 lbs. (1360 kg) of selenium per year. At current market rates, that mass of selenium is worth about USD $90,000 to $120,000.

### FIGURES

FIG. 1 shows a schematic process flow diagram for a plant for recovering selenium from bioreactor sludge.

FIG. 2 shows a schematic process flow diagram for another plant for recovering selenium from bioreactor sludge.

### DETAILED DESCRIPTION

In a process for removing or recovering selenium, a feed flow of wastewater containing selenium enters a bioreactor. For example, the feed flow may be flue gas desulphurization blowdown water from a coal fired power plant. In the bioreactor, microorganisms convert soluble forms of selenium into insoluble elemental selenium. The bioreactor may be an ABMet™ reactor available from GE Water and Process Technologies, a business within the General Electric Company. In this form of bioreactor, water to be treated flows through a fixed media bed that supports the microorganisms. The elemental selenium is retained as particles with biomass in the bioreactor. Treated water flows out of the bioreactor, preferably with a selenium concentration reduced to below discharge limits. The bioreactor is periodically flushed producing sludge, which contains biomass, elemental selenium, ions and suspended solids that were present in the feed flow.

International Publication Number WO 2007/012181 describes a suitable bioreactor and process for treating wastewater contaminated with selenium and is incorporated herein by this reference to it. Other bioremediation processes may also produce an effluent or sludge containing selenium. For example, selenium may be removed from wastewater in a membrane bioreactor containing a suspended growth of selenium reducing organisms. Elemental selenium is discharged in a sludge drawn from the bottom of a process tank or a separate membrane vessel.

The sludge may be sent to sludge thickening device to produce a thickened sludge. The sludge thickening device may be, for example, one or more of a settling tank, a centrifuge, a filter press or a belt thickener. Excess water released from the sludge may be sent to a separate wastewater treatment plant or recycled to a point upstream of the bioreactor. The thickened sludge may contain 10-30 wt % solids. The solids comprise cells of microorganisms released from the bioreactor, other suspended solids that were present in the feed water sent to the bioreactor and are still retained in the thickened sludge, and elemental selenium that has been reduced by the microorganisms. In one sample of a thickened sludge taken from an ABMet reactor treating flue gas desulphurization blowdown water from a coal-fired power plant, the solids in the thickened sludge were composed of about 51% microorganism cells, about 48% other suspended solids, and a small percentage, about 1%, of selenium. A trace amount, less than 0.1%, of nickel was also present. The other suspended solids were primarily minerals such as gypsum particles, fly ash and limestone particles. In other applications, the concentration of selenium may be higher, up to about 10 wt %.

The thickened sludge might need to be disposed as non-hazardous waste due to its high selenium concentration. In the USA, the thickened sludge would have to be put through the Toxicity Characteristic Leaching Procedure (TCLP) to determine how the thickened sludge must be handled. If the TCLP result is over 1.0 mg/L, the thickened sludge must at least be stored in a hazardous waste landfill area. If the TCLP result if over 5.7 mg/L, which is possible, then the thickened sludge must be sent to a waste management company at great expense. In the processes to be described below, however, the bioreactor sludge is treated in a recovery process to remove at least some of the remaining selenium, preferably such that any remaining sludge to be discharged has a TCLP of 1 mg/L or less.

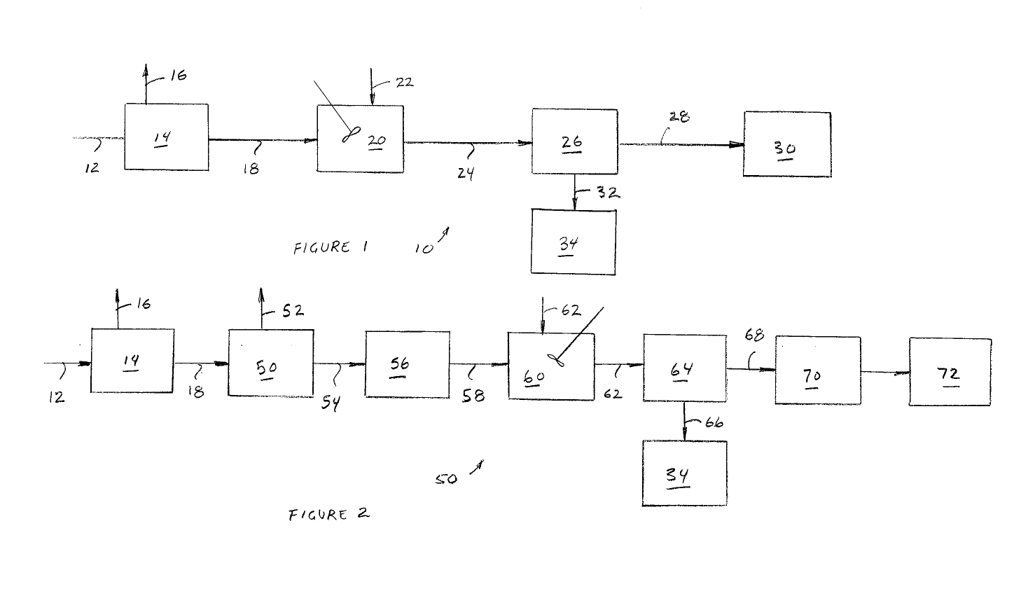

FIG. 1 shows a first plant 10 for recovering selenium from bioreactor sludge. Raw sludge 12, for example as produced by backwashing or flushing an ABMet reactor, is collected in a settling tank 14. Optionally, a clarifier may be used. The sludge is allowed to settle by gravity in the settling tank 14. A supernatant 16 is drawn out of the settling tank 14. The supernatant may be discharged, after further treatment if required, or sent back to a point upstream of the bioreactor.

Settled sludge 18 is taken from the bottom of the settling tank 14 to mixing tank 20. Chemicals 22 are added to the mixing tank 20 and mixed in with the sludge 18. The chemicals 22 disrupt the exopolymer coating on the outside of microorganism cells in the sludge. The chemicals 22 may comprise, for example, a surfactant. One example of a suitable surfactant is polysorbate (80). With the adhesion of the selenium particles to the cells disrupted, mixing or other agitation can liberate the selenium particles from the cells.

A washed sludge 24 is taken from the mixing tank 20 to a separation device 26. The selenium particles are smaller and denser than the cells. The separation device 26 is thus configured to separate the cells from the selenium particles by density or by size. For example, in a centrifuge the selenium particles are produced in a de-watered form in a centrate since the cells have a density less than or similar to water. Alternatively, in a filter with a pore size large enough to pass the selenium particles but small enough to retain the cells the selenium is separated with water from the cells. For example, the filter pores may be about 0.25 um to 0.5 um. The selenium particles may then be separated from the water by a second stage filter having a pore size less than most of the selenium particles. For example, the second stage filter may have pores of 0.1 um or less.

Selenium reduced sludge 32 drawn from the separation device 26 may be sent to a further processing unit 34. For example, the selenium reduced sludge 32 may be treated in an anaerobic sludge digester, followed by de-watering, to reduce its volume for disposal. Alternatively, the selenium reduced sludge may be sent upstream of the bioreactor to be used as a nutrient source for the bioreactor.

Separated selenium 28 may be transferred from the separation device 26 to a refining unit 30. The separated selenium 28 is likely to still have some water associated with it, as well as some cells and exopolymer fragments. The organic materials may be removed, for example, by cell lysis, aerobic or anaerobic digestion, burning or other techniques. The water may be removed, for example, by filtration or a press followed by evaporation.

FIG. 2 shows a first plant 50 for recovering selenium from bioreactor sludge. As in the first plant 10, raw sludge 12, is collected in a settling tank 14 or clarifier. The sludge is allowed to settle by gravity. A supernatant 16 is drawn out of the settling tank 14 and may be discharged, after further treatment if required, or sent back to a point upstream of the bioreactor.

Settled sludge 18 is taken from the bottom of the settling tank 14 to a sludge de-watering unit 50. The sludge dewatering unit 50 may be, for example, a centrifuge, filter press or belt thickener. Excess water 52 is removed leaving a thickened sludge 54 having a solids content of, for example, 20-30% by volume. The thickened sludge 54 is transferred to a sludge dryer 56 to further increase the solids content. The dryer 56 may be, for example, a thermal or solar dryer as used in treating waste activated sludge. The dryer 56 produces a dried sludge 58 having a very high solids content, for example 80% by volume or more, or 90% by volume or more.

The dried sludge 58 is sent to a mixing tank 60. Chemicals 62 are added to the mixing tank 60 to dissolve the selenium. Elemental selenium nanospheres can be dissolved in the presence of an oxidizer at a high pH. The oxidizer may be, for example, Cl₂, H₂O₂ or MnO₄. The pH is preferably increased to about 9 or more. The pH may be increased by adding a second chemical, for example NaOH.

A slurry 62 is drawn from the mixing tank 60 and sent to a filtration unit 64. The filtration unit has a pore size small enough to retain the cells. For example, the pores may be about 0.5 um or less. The retentate 66 is sent to a sludge processing unit 34 as described above. A filtrate 68 drawn from the filtration unit 64 consists generally of a concentrated brine of soluble selenium, possibly with some other remnant soluble or colloidal substances. The filtrate 68 has a selenium salt concentration similar to that found in selenium refining operations. The filtrate 68 may thus be sent to a selenium refining operation 70 operating to refine mined selenium, or treated similarly on-site. For example, a selenium brine may be refined by electro-winning. Alternatively, or after refining, the filtrate 68 may be dried in an evaporator 72, for example by thermal or solar process, to produce a dried salt product. As a further alternative, the selenium can be precipitated from the filtrate 68 through pH adjustment and precipitation via chemical reduction.

1. A process for recovering selenium from bioreactor sludge, the sludge comprising elemental selenium particles attached to microorganisms capable of reducing soluble forms of selenium, the process comprising steps of,
a) disrupting the attachment between the microorganisms and the selenium particles; and,
b) separating the selenium particles from the microorganisms.

2. The process of claim 1 wherein step a) comprises mixing or agitating the sludge.

3. The process of claim 2 wherein step a) comprises adding a surfactant to the sludge.

4. The process of claim 1 wherein step b) comprises passing the sludge through a centrifuge.

5. The process of claim 1 wherein step b) comprises passing the sludge through a first filter having a pore size large enough to pass most of the selenium particles but small enough to retain most of the microorganisms.

6. The process of claim 5 wherein step b) further comprises passing a filtrate from the first filter through a second filter having a pore size small enough to retain most of the selenium particles.

7. A process for recovering selenium from bioreactor sludge, the sludge comprising elemental selenium and microorganisms capable of reducing soluble forms of selenium, the process comprising steps of,
a) thickening the sludge;
b) dissolving selenium in the thickened sludge;
c) filter microorganism from the product of step b); and;
d) refining a filtrate from step c) to isolate selenium salts.

8. The process of claim 7 wherein step b) comprises mixing an oxidant into the sludge at a pH of about 9 or more.

9. The process of claim 8 wherein the oxidant is one or more of Cl2, H2O2 and MnO4.

10. The process of claim 7 wherein step c) comprises passing the product of step b) through a filter having a pore size of 0.5 um or less.

11. The process of claim 7 wherein step a) comprises passing the sludge through a sludge thickener and a sludge dryer, whereby the solids content of the sludge is increased to about 80% by volume or more.

12. The process of claim 7 wherein in step d) liquid is evaporated from the filtrate.

13. The process of claim 7 wherein in step d) the filtrate is treated by electro-winning.

14. The process of claim 7 wherein selenium is precipitated from the filtrate through pH adjustment and precipitation via chemical reduction.
